(19) United States
(12) Patent Application Publication
(10) Pub. No.: US 2005/0025142 A1
(43) Pub. Date: Feb. 3, 2005

(54) Telecommunications and data communications switching apparatus and method

(76) Inventors: Andrew James Barker, Nottingham (GB); Jonathan Munns, Nottingham (GB); Laurence Arden, Nottingham (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/483,686

(22) PCT Filed: Jul. 19, 2002
(86) PCT No.: PCT/GB02/03320

(30) Foreign Application Priority Data
Jul. 25, 2001 (GB) 0118158.5

(51) Int. Cl. H04L 12/56

(52) U.S. Cl. 370/389; 370/369

(57) ABSTRACT

To perform non-blocking cross connections in a high data rate switch operative for switching a synchronous data stream where the data is arranged in groups, the bits of the data groups are spread into subsets of one or more bits and the subsets switched individually across lower bit rate switches. At the destination the subsets are recombined. The bit spreader and recombiner may be arranged on the switch card or at the source and destination interfaces respectively. A protection switch can provide 1:N protection and an XOR function can be incorporated with the protection switch to provide 1:N protection without signalling from the destination interface to the source interface.

This invention relates to telecommunications and data communications switches, and in particular to switches which can perform full non-blocking cross connections. It also relates to a switching method.

Within the context of an SDH (Synchronous Digital Hierarchy) multiplexer, to perform full non-blocking cross connections it is necessary to provide a single switch matrix with sufficient capacity to cross connect all interfaces. The switch may be realised in a simple ASIC, circuit boards, racks of equipment, or any combination using a Clos structure.

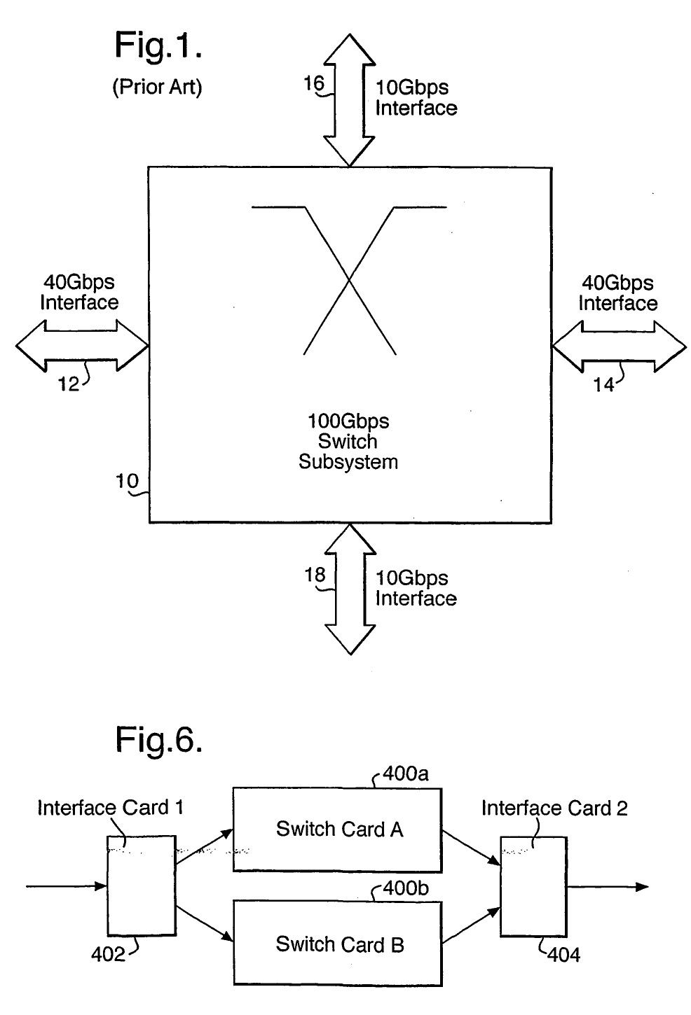

FIG. 1 shows a typical switch subsystem 10 which has two 40 Gbps interfaces 12, 14 and two 10 Gbps interfaces 16, 18. These interfaces require a minimum total switch capacity of 100 Gbps.

If all the interfaces of FIG. 1 were doubled, the required switch capacity would then be 200 Gbps. In practice, to maintain a fully non-blocking switch, the resources required to implement such a switch are quadrupled rather than doubled. This is highly disadvantageous and may not be technologically viable at present. In addition, if it is viable, it may be uneconomical to implement.

It has been proposed (EP-A-0 905 996) to spread of groups of bits in a synchronous data stream into subsets of one or more bits and to provide for the individual switching of each of the subsets. This has the advantage that a high data rate non-blocking cross connect switch can be constructed using a number of lower rate switches each of which switches data subsets of one or more bits. This allows a fully non-blocking switch to be provided at capacities beyond those previously possible.

Further, it has been proposed to provide (EP-A-1 061 766) a protection switch for providing an alternative switching path for a data subset in the event of failure of one of the switches. A single protection switch provides 1:N protection, where N is the number of switches, being fed with a parity stripe to permit the data stored in the switching fabric that failed to be reconstructed.

The invention provides apparatus for switching a synchronous data stream between a first interface and a second interface, the data bits of the synchronous data stream being divided into groups of bits, comprising:
a bit spreader for splitting the groups of data into two or more subsets;
a plurality of switches each for switching one of the two or more subsets of data;
a bit recombiner for recombining the switched subsets of bit groups to reform the bit group, and
a protection switch for providing an alternative switching path for a data subset between the first and second interfaces in the event of failure of one of the plurality of switches, characterised by
an exclusive OR function XOR at each of the bit spreader and the bit recombiner, the XOR function at the bit spreader receiving as data inputs the bits of the data subsets and outputting an XOR function of the input bits to the protection switch, the XOR function at the bit combiner receiving as a first input, the data bits switched by the protection switch and as further inputs the data bits switched by all but a failed one of the plurality of switches, wherein the output of the XOR function comprises the switched bits of the data bits passed to the failed switch.

The invention also provides a method of switching a synchronous data stream from a first interface to a second interface, the data stream comprising data bits arranged in groups, comprising:
splitting the groups of data into two or more subsets;
switching each of the subsets of data separately;
recombining the switched subsets, and
switching a lost data subset via a protective switch,
   characterised by,
at the first interface, performing an exclusive OR function (XOR) on the bits of the data subsets to provide an XOR output, and switching the XOR output via the protective switch; and at the second interface, on detection of the loss of one of the data subsets, performing an XOR function with the XOR output and the remaining switched data subsets to recreate the lost data subset.

This has the advantage that a lost data subset is recreated synchronously via the protection switch.

Preferably, the bit spreader is arranged at the first interface and the bit recombiner at the second interface. This has the advantage that the amount of connections required is spread over the plurality of switches, each of which may be on a separate switch card. This avoids problems with lack of available connections, reduces the track routing demands on the backplane which connects the switch cards and the interfaces, and also allows more switch interfaces to be supported. Furthermore, it has the advantage that the demand on switch card area and power dissipation is reduced as it is spread over a number of cards.

Preferably the bit spreader and bit combiner each include a bit combiner and bit spreader respectively whereby data can be switched from the first to the second interface or vice-versa.

Embodiments of the invention will now be described, by way of example, and with reference to the accompanying drawings, in which:

FIG. 1, referred to previously, is a schematic diagram of a 100 Gbps switch subsystem;

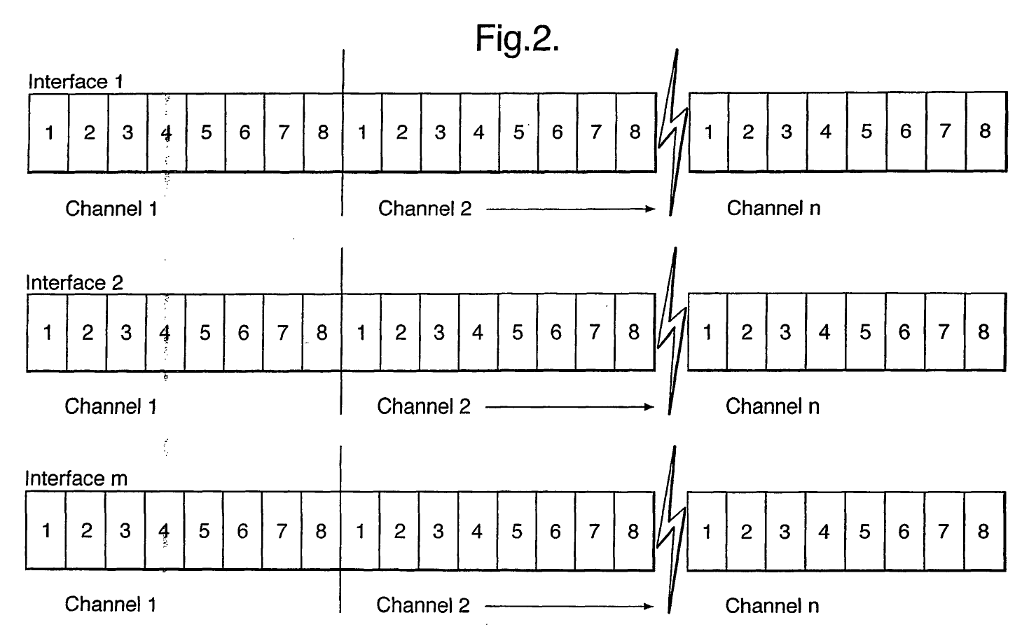

FIG. 2 shows how serial bit streams at interfaces to a switch may be grouped;

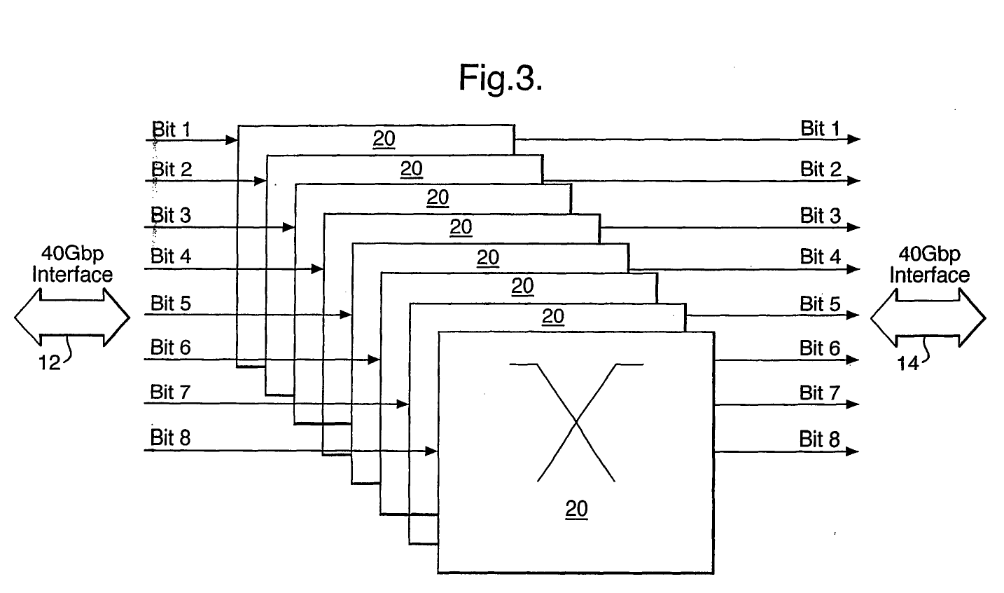

FIG. 3 is a diagrammatic representation of a bit spreading switch;

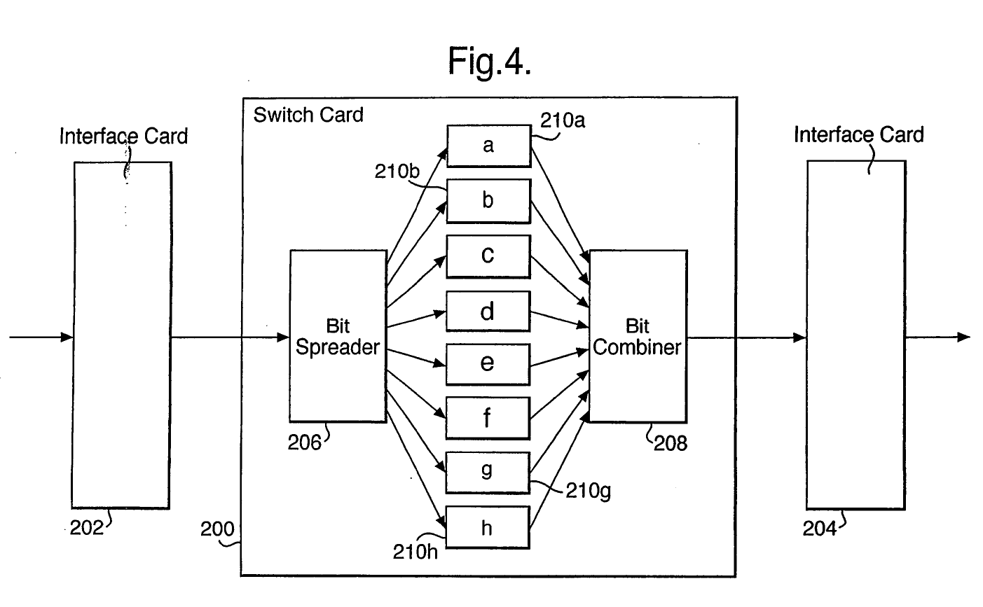

FIG. 4 shows bit spreading on a switch card;

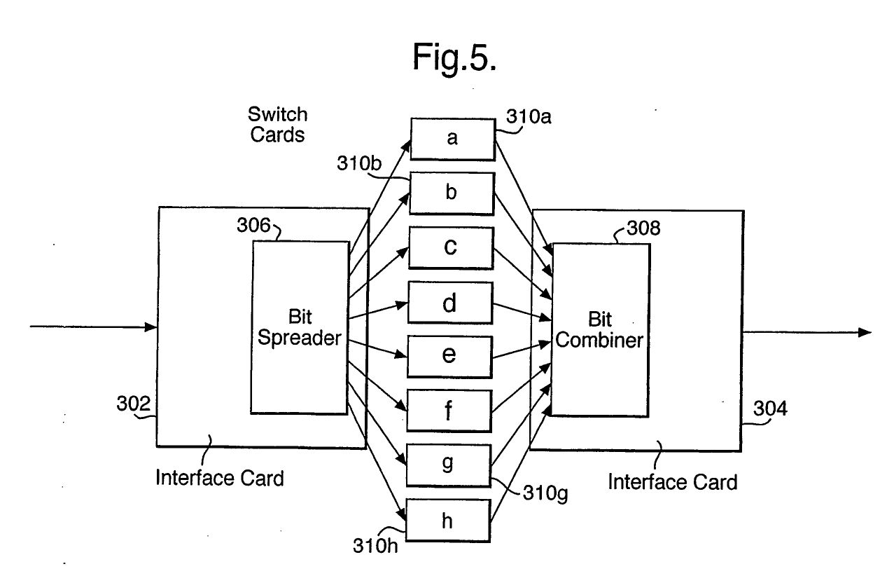

FIG. 5 shows bit spreading on interface cards;

FIG. 6 shows the how the arrangement of FIG. 4 would have to be used to introduce switch card protection;

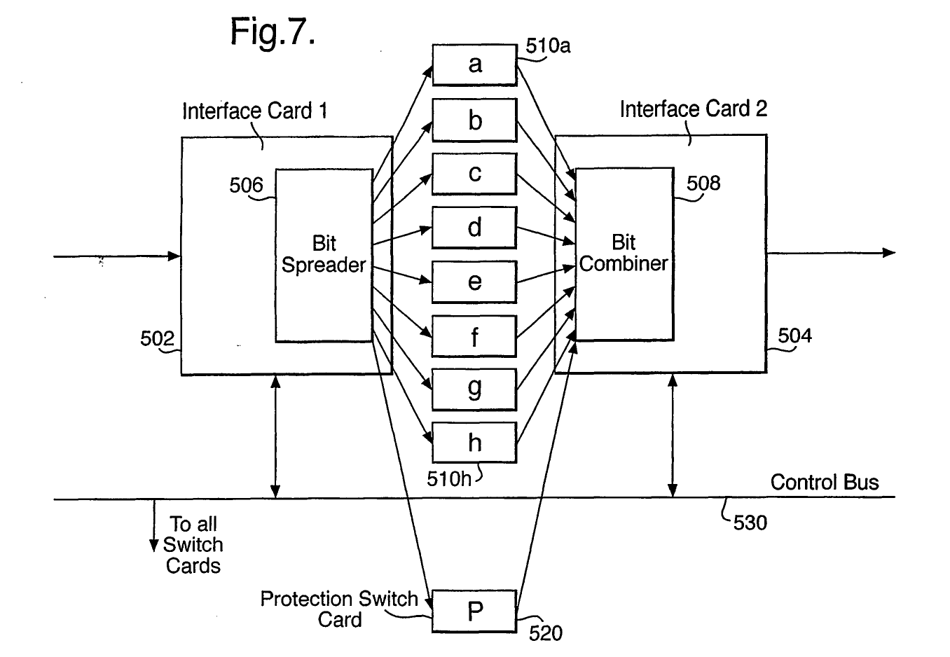

FIG. 7 shows 1:N switch card protection; and

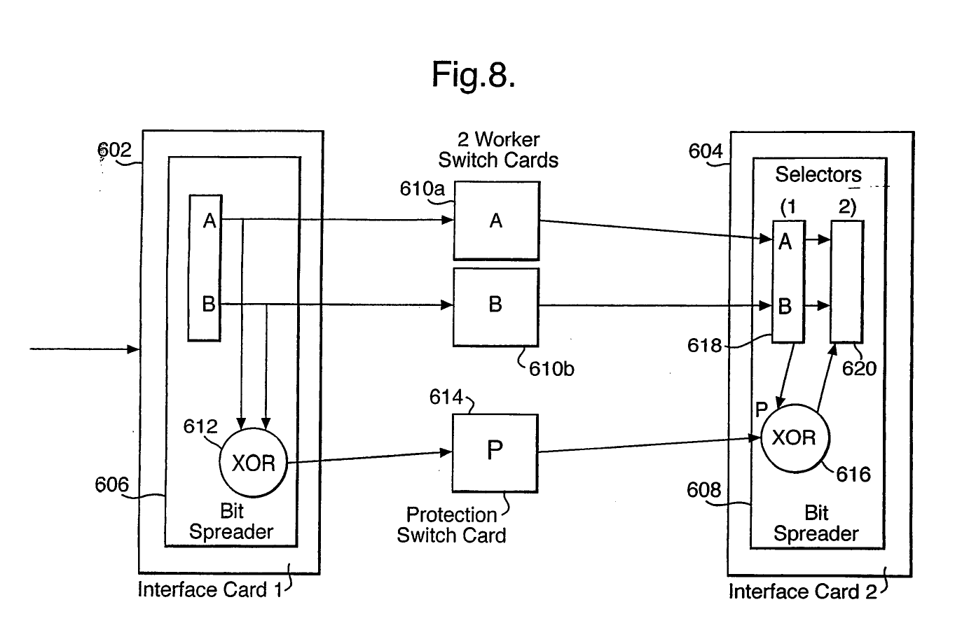

FIG. 8 shows the XOR function used in the 1:N switch card protection of the invention.

In the arrangements to be described, the switch is spread across many subsystems in parallel. This technique is applicable to any synchronous data system in which data is grouped. The arrangements to be described refer particularly to SDH in which data bits are transmitted serially and are grouped in bytes or octets. This is illustrated in FIG. 2 which shows the serial bit streams at three interfaces 1, 2 and M. Each channel 1, 2, . . . n consists of 8 bits which are transmitted sequentially and, for switching purposes, are grouped together.

To perform a full non-blocking cross-connection, in this example the switching subsystem must be able to connect all 8 bits from one channel to the 8 bits of any other channel in the interface. For example, it may be required to switch channel 2 of interface 1 to channel 3 of interface 2. This requires bits 1-8 of channel 2 interface 1 to be connected across to bits 1-8 of channel 3 of interface 2. The bit sequence integrity must always be maintained when performing the connection.

Although the whole data group of 8 bits, or whatever the size may be, must be switched from the same source to the same destination with their sequence integrity maintained, the bits of the data group do not need to be switched together through the same physical switch.

FIG. 3 shows how the individual bits of each channel can be switched separately and then combined at the output interface to from the required channel. It will be appreciated that the bits and their sequence have to be maintained at their input and output interfaces but do not have to be switched as a complete unit which, in the SDH example is 8 bits.

Thus, in FIG. 3, the bits of each channel are distributed from each individual interface and channel, allowing each bit to be switched separately without compromising the non-blocking nature of the switch.

In the FIG. 3 example, 8×12.5 Gbps switches 20 are used, with each switch switching one of bits 1-8 of a channel of the 40 Gbps interface 12 across to a channel of the other 40 Gbps interface 14. The 100 Gbps switch can therefore be achieved using a number of smaller switches, in this case 8×12.5 Gbps switches.

It should be appreciated that in FIG. 3, the two 10 Gbps interfaces have been omitted for clarity.

In the FIG. 3 example, it can be seen that doubling the total switch capacity from 100 Gbps to 200 Gbps would require each of the individual switch subsystems to be doubled form 12.5 Gbps to 25 Gbps. This represents a small technological step which can be achieved far more easily and economically than a single 200 Gbps switch.

If, as suggested in this example, the maximum switch size that can be economically realised is 100 Gbps then it can be seen that by spreading the bits of a 8 bit data group across 8 switch subsystems an 800 Gbps fully non-blocking switch would be built; this is 8 times greater than prevailing technology limitations would suggest. It should be noted that ASIC technology is developing so fast that capacities are increasing between 2 and 4 times per year. In 1996 a 1.25 Gbps switch could be realised on 1 chip. By 2002, 20 Gbps will be delivered on 1 chip.

As mentioned above, the principle of the invention (to be described hereinafter with reference to FIG. 8) may be used with any synchronous data system in which data is grouped into words of two or more bits. However, the bits making up the words need not be switched individually but may be switched in pairs, groups of four bit nibbles, or another sub-multiple of the data word size.

FIGS. 4 and 5 show two possible implementations of the bit spreading techniques described above. Most applications consist of a central switch which interfaces to a range of traffic, or interface cards. The bit spreading technique may therefore be implemented either on the switch card or on the traffic interface cards.

FIG. 4 shows a theoretically possible arrangement in which spreading is implemented of the switch card. In FIG. 4, for the sake of clarity, only two interfaces are shown and data is shown flowing only from left to right. In practice, many interfaces are provided with data flow between any given interface and any other interface.

In the illustration of FIG. 4 it is assumed that all the cards fit into a main backplane PCB which provides the intercard connections as is standard practice in the datacomms/telecomms industry.

Thus in FIG. 4, two interface cards 202, 204 connect to a switch card 200. Data is shown as flowing left to right in the direction of the arrows. Mounted on the switch card 200 are a bit spreader and bit combiner 206, 208. With the given data flow direction, bit spreader 206 receives 8 bit data groups from the interface card 202 and splits them into 8 separate one bit data streams which are provided to 8 switch subsystems 210a-210h. In the 100 Gbps example, each of the switch subsystems 210a-210h is a 12.5 Gbps switch. Bit combinerspreader 208 recombines the bits switched by the switch subsystems 210 to reform the 8 bit groups and passes the recreated groups to interface card 204. The bit spreader and bit combiner 206, 208 can each disassemble or reassemble the data groups depending on the direction of dataflow. Thus, each includes a bit spreader and bit combiner.

The FIG. 4 arrangement would have the advantage that the switch devices are smaller than would be required if the data were switched in one device. The bit spreading technique is transparent to the interface cards which see a switch interface of a standard n bit width.

However, the embodiment of FIG. 4 would have a number of disadvantages in that it does not address other problems associated with large switches. In particular, there are three particular difficulties:
a) Switch card electrical connection capacity. As data rates and interface card support increases, an increasing number of interfaces are required to connect into the switch card. This puts increasing demand on the connection count of the card.
b) The large number of devices required to implement the switch card may not fit easily onto a single card, both physically in terms of card area and in terms of heat dissipation.
c) Data protection can only be achieved using 1+1 protection providing complete protection of all the switch card hardware and requiring a complete second switch card assembly to guard against failure of any of the components of the switch card.

The arrangement of FIG. 5 implements bit spreading on the interface cards and, as will be described with reference to FIG. 6 to 8, avoids the disadvantages of the FIG. 4 arrangement.

As with FIG. 4, for simplicity, FIG. 5 only shows two interfaces and shows data flow only from left to right. It is also assumed that the cards all interconnect via a backplane. A bit spreader combiner 306, 308 is arranged on each of the interface cards 302, 304 and bit spreader 306 spreads the bits of the data groups to each of the switch cards 310a-310h as before. Bit combiner 308 on destination card 304 recombines the switched data.

Bit spreading on the interface cards has three main advantages. As only a fraction of the data from each interface card is required by each switch card, the connection count is also spread over the switch cards.

This reduces the individual switch card connection count problem and reduces the demands on the routing of tracks on the PCB backplane used to inter-connect the cards. Moreover, it increases the total number of switch interfaces that can be supported as more total connections are available.

The arrangement of FIG. 5 has the further advantage that the demand on card area and power dissipation is substantially reduced, being spread over a number of cards, in this case 8. It has the further advantage that 1:N switch card protection can be used instead of protecting the whole switch plane as will now be described.

FIG. 6 illustrates 1+1 switch plane protection which would have to be used with the FIG. 4 embodiment and which has traditionally been used by the data/telecomms industry to protect the switch plane. In essence, a second switch plane is provided and the target interface selects from which switch card it uses received data. In FIG. 6, two switch cards 400a, 400b, are connected between two interface cards 402 and 404. Interface card 402 sends its traffic to both switch cards 400a, 400b and interface card 404 receives traffic from both cards 400a, 400b and selects the traffic from one of the switch cards in accordance with the appropriate failure criteria.

FIG. 7 shows how bit spreading of traffic on the interface cards allows a different solution to protection using a 1:N technique.

In FIG. 7, the arrangement is the same as FIG. 5 and like components are shown with the same reference increased by 200. In addition, an extra protection switch card 520 is added. The bit spreader 506, for the data flow direction shown, can send data representing any of the main cards 510 according to which one is required to overcome a failure.

For example, assume that switch card 510c fails. Interface card 504 will detect the failure and signal back to interface card 502 that data from switch card 510c has been lost. Interface card 502 will then send data intended for card 510c, that is every third bit of each channel, to protection switch card 520. Interface card 504 can treat data received from protection switch card 520 as data received from the failed card 510c and so overcome the problem.

The failure can be signalled by interface card 504 either over the data path of the protection card itself, or via a common control bus 530 connecting all the cards.

Thus, a single additional switch card of the same capacity of each of the switch cards 510a-h, can provide for failure of any one of the switch cards 510.

The arrangement of FIG. 7 is highly advantageous but has the disadvantage that interface card 504 must signal back to interface card 502 that there has been a failure. There will be a period, therefore, in which data is lost until the data for the failed card is rerouted through the protection card 520.

In accordance with the invention, the embodiment of FIG. 8 implements bit-spreading as described with reference to FIGS. 5 and 7, while allowing data to be restored, and protection initiated, without any signalling between the interface cards regarding the nature of the failure.

This is achieved by sending data across the protection card that carries information in a way that allows the receiving interface card to reconstitute the original data without signalling back to the source card.

This is achieved using a logical Exclusive OR function (“XOR”). Table 1 shows the logic table for a 2 bit XOR:

TABLE 1

| A | B | XOR AB |
|---|---|---|
| 0 | 0 | 0 |
| 0 | 1 | 1 |
| 1 | 0 | 1 |
| 1 | 1 | 0 |

For the purposes of clarity, FIG. 8 is a simplified system having 2 data bits. These 2 bits are bit spread, using bit spreaders 606, 608 arranged on interface cards 602, 604 through two switches 610a, 610b and protected by a third bit.

It can be seen from FIG. 8 that the bit spreaders now have an XOR function with the source interface card having an XOR 612 which receives data inputs A, B consisting of the two data bits. The output of the XOR function is provided to the protection switch card 614 and switched as an input to XOR function 616 of the destination interface card bit spreader 608. That XOR function has as its other input the output from a first selector 618 on the destination interface card which can select either of the two switched bits as the input.

The destination interface card 604 usually takes its data from the two switch cards. However, in the event of a failure on one of these cards, the remaining card data is XOR'd with the data from the protection card. Due to the nature of the logical XOR function, the output of the XOR function is the data input from the failed card. This can be understood by considering the outputs of the two XOR functions, 612 and 616, when switch card 610a fails and the data B bits from card 610b are XOR'd with the protection switch card data bits. This is shown in table 2.

TABLE 2

| | | | XOR Output on |
|---|---|---|---|
| | | Protection Switch | Interface 604 |
| Data A | Data B | Input (A xor B) | (B xor P) |
| 0 | 0 | 0 | 0 |
| 0 | 1 | 1 | 0 |
| 1 | 0 | 1 | 1 |
| 1 | 1 | 0 | 1 |

Thus it can be seen that the XOR output B xor P is the same as A.

Table 3 shows the situation where card 610b fails and the Data A bits from card 610a are XOR'd with the protection switch card data bits.

TABLE 3

| | | Protection Switch | XOR Output on Interface |
|---|---|---|---|
| Data A | Data B | Input (A xor B) | 604 (A xor P) |
| 0 | 0 | 0 | 0 |
| 0 | 1 | 1 | 1 |
| 1 | 0 | 1 | 0 |
| 1 | 1 | 0 | 1 |

Here it can be seen that the XOR output A xor P is the same as the data B bits.

Thus, it can be seen that the XOR functions enable the lost data stream to be reconstructed precisely. The reconstructed data stream is passed to a second selector 620 to pass the data from the working switch card 610a/b and the XOR output to form the required data outputs.

Although described with respect to 2 bits for simplicity, the embodiment of FIG. 8 will work with any number of bits, for example 8 and allow for replacement of any one of those spread bits streams where a switch card has failed. No signalling is required from the destination switch card to the source switch card and any loss in data is minimal.

In summary, the invention described enables full access switching at very high speeds to be achieved in a synchronous data system by spreading the bits forming a repetitive sequence in the transmission protocol over a number of switch paths allowing high switch rates to be achieved using existing technology, and providing protection without the need for signalling between the interface cards.

Many modifications to the embodiments described are possible and will occur to those skilled in the art without departing from the invention. For example, synchronous data transmission protocols other than SDH are suitable provided that data is transmitted in regular groups of bits of the same length.

1-9: (Canceled)

10: An apparatus for switching a synchronous data stream between a first interface and a second interface, the synchronous data stream having data bits divided into groups of data, comprising:
a) a bit spreader for splitting the groups of data into a plurality of data subsets;
b) a plurality of switches each for switching one of the plurality of data subsets into switched subsets;
c) a bit recombiner for recombining the switched subsets to reform the group;
d) a protection switch for providing an alternative switching path for a data subset between the first and second interfaces in the event of failure of one of the plurality of switches; and
e) an exclusive OR (XOR) function at each of the bit spreader and the bit recombiner, the XOR function at the bit spreader receiving, as data inputs, the bits of the data subsets and outputting an XOR function of the input bits to the protection switch, the XOR function at the bit combiner receiving, as a first input, the data bits switched by the protection switch and, as further inputs, the data bits switched by all but a failed one of the plurality of switches, the XOR function generating, as an output, the switched bits of the data bits passed to the failed one switch.

11: The apparatus according to claim 10, wherein the groups of bits are divided into data subsets each having a single bit, and wherein a number of the switches in the plurality of switches equals a number of bits in each group.

12: The apparatus according to claim 10, wherein the bit spreader is arranged at the first interface, and wherein the bit recombiner is arranged at the second interface.

13: The apparatus according to claim 12, wherein the plurality of switches each comprises a separate switch card.

14: The apparatus according to claim 10, wherein the synchronous data stream comprises a synchronous digital hierarchy (SDH) bit stream.

15: The apparatus according to claim 10, comprising at least one further interface, wherein the plurality of switches is operative to switch the data subsets among any of the first interface, the second interface and the at least one further interface.

16: The apparatus according to claim 10, wherein the bit spreader includes a bit recombiner for recombining data subsets received from another interface, and wherein the recombiner includes a bit spreader for dividing the bit groups from the second interface to said another interface across the plurality of switches.

17: A method of switching a synchronous data stream from a first interface to a second interface, the synchronous data stream comprising data bits arranged in groups of data, comprising the steps of:
a) splitting the groups of data into a plurality of subsets of data;
b) switching each of the subsets of data separately into switched subsets;
c) recombining the switched subsets; and
d) switching a lost data subset via a protective switch by
i) at the first interface, performing an exclusive OR (XOR) function on the bits of the data subsets to provide an XOR output, and switching the XOR output via the protective switch, and
ii) at the second interface, on detection of loss of one of the data subsets, performing an XOR function with the XOR output and the remaining switched data subsets to recreate the lost data subset.

18: The method according to claim 17, wherein the subsets of data each comprises at least one data bit.
